(19) United States
(12) Patent Application Publication
(10) Pub. No.: US 2019/0294594 A1
(43) Pub. Date: Sep. 26, 2019

(54) Identity Data Enhancement

(71) Applicant: Skyrock Partners, LLC, Austin, TX (US)

(72) Inventors: Hank Weghorst, Austin, TX (US); Ray Renteria, Austin, TX (US); Patrick Motola, Austin, TX (US)

(21) Appl. No.: 16/284,330

(22) Filed: Feb. 25, 2019

Related U.S. Application Data
(60) Provisional application No. 62/646,103, filed on Mar. 21, 2018.

(51) Int. Cl. G06F 16/215; G06F 16/28; G06F 16/27; H04L 29/08

(52) U.S. Cl. CPC G06F 16/215; H04L 67/306; G06F 16/27; G06F 16/285

(57) ABSTRACT

A method, system and computer-usable medium for performing a data management operation, comprising: receiving an original identity dataset, the original identity dataset comprising a plurality of records; enhancing the plurality of records of the original identify dataset based upon a context to provide an enhanced trait identity dataset comprising a plurality of enhanced trait identity records; and, performing a match operation on the enhanced trait identity dataset to provide an enhanced match identity dataset comprising a plurality of enhanced match identity records.

### BACKGROUND OF THE INVENTION

### Field of the Invention

The present invention relates in general to the field of computers and similar technologies, and in particular to software utilized in this field. Still more particularly, it relates to a method, system and computer-usable medium for automating the enhancement of identity data.

### Description of the Related Art

Despite the quantity of data that has become widely available in recent years, identifying, collecting, aggregating and maintaining pertinent and accurate identity information related to entities of all kinds can prove challenging. Furthermore, the identity data that may be readily available may not be suitable for a given purpose. As an example, having a mailing list, regardless of how accurate the physical address information it contains may be, is of little use if the intended use is for an email campaign. Likewise, an accurate list of email addresses and their corresponding users may be of limited value without corresponding profession or job title information.

Accordingly, it is not uncommon for large organizations to devote significant resources, financial and otherwise, to maintaining such identity information related to their members or constituents. However, many professionals struggle to access or integrate the identity data they need, in part due to the limitations of existing tools and the prohibitive cost of time and resources required to do the work manually. Furthermore, data entry errors, stale identity information, contradictory data of all kinds, and hard-to-identify duplicate records not only increases costs, but can decrease operational efficiency as well.

### SUMMARY OF THE INVENTION

A method, system and computer-usable medium are disclosed for automating the enhancement of identity data.

In various embodiments, the invention relates to a method, system and computer-usable medium for performing an identity data management operation, comprising: receiving an original identity dataset, the original identity dataset comprising a plurality of records; enhancing the plurality of records of the original identify dataset based upon a context to provide an enhanced identity dataset comprising a plurality of enhanced identity records; and, performing a match operation on the enhanced identity dataset to provide a matched identity dataset comprising a plurality of matched identity records.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an identity data enhancement process;

FIG. 3 is a simplified block diagram of the operation of an identity data enhancement system;

FIG. 4 is a simplified block diagram of the transformation of a truncated original identity data record into an enhanced matched identity data record;

FIG. 5 is a simplified block diagram of the transformation of a partially populated original identity data record into an enhanced matched identity data record; and

FIGS. 6a through 6c are a generalized flowchart of the performance of automated identity data enhancement operations.

### DETAILED DESCRIPTION

A method, system and computer-usable medium are disclosed for automating the enhancement of identity data. Certain aspects of the invention reflect an appreciation that an organization may possess, or have access to, identity data stored in various forms and locations. Certain aspects of the invention likewise reflect an appreciation that subsets of such identity data may be incomplete, incorrect, or incorrectly formatted. Likewise, certain aspects of the invention reflect an appreciation that known approaches for overcoming such identity data defects include Master Data Management (MDM). Skilled practitioners of the art will be familiar with MDM, which in typical implementations reconciles and rationalizes customer data spread across multiple data silos, with the goal of producing a single “golden” reference identity record for each entity. Those of skill in the art will also be aware that while MDM is often successful at producing such reference records, its initial implementation and ongoing maintenance can be both costly and complicated.

Accordingly, certain aspects of the invention reflect an appreciation that it would be advantageous for certain individuals and organizations to realize the benefit of MDM without having to make a significant investment of resources, financial or otherwise. Certain embodiments of the invention likewise reflect an appreciation that many MDM approaches are oriented to customer data, which changes infrequently. Likewise, certain embodiments of the invention reflect an appreciation that marketers, and other professionals, may need access to accurate identity information that may change on a frequent basis, as well as being based upon different demographics and other parameters.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a mobile device such as a tablet or smartphone, a connected “smart device,” a network appliance, a network storage device, a cloud based system, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more storage systems, one or more network ports for communicating externally, as well as various input and output (I/O) devices, such as a keyboard, a mouse, and a graphics display.

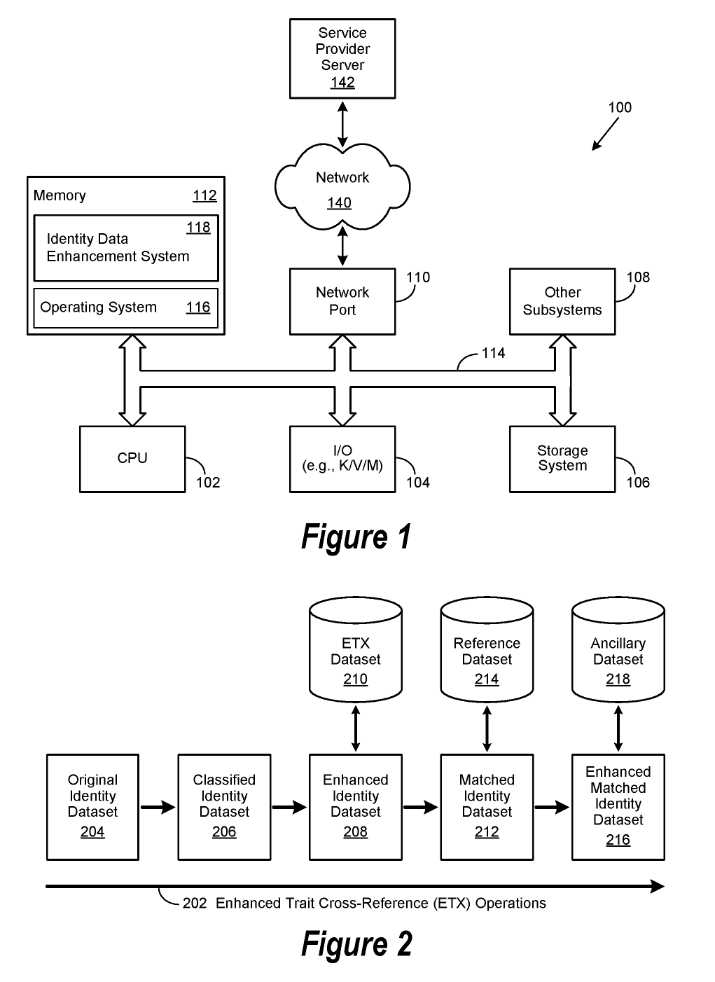

FIG. 1 depicts an exemplary information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes operating system (OS) 116 and in various embodiments may also include an identity data enhancement system 118. In one embodiment, the information handling system 100 is able to download the identity data enhancement system 118 from the service provider server 142. In another embodiment, the identity data enhancement system 118 is provided as a service from the service provider server 142.

In various embodiments, the identity data enhancement system 118 performs an identity data enhancement operation. In certain embodiments, the identity data enhancement operation improves processor efficiency, and thus the efficiency of the information handling system 100 by performing the identity data enhancement operation. As will be appreciated, once the information handling system 100 is configured to perform the identity data enhancement operation, the information handling system 100 becomes a specialized computing device specifically configured to perform the identity data enhancement operation and is not a general purpose computing device. Moreover, the implementation of the identity data enhancement system 118 on the information handling system 100 improves the functionality of the information handling system 100 and provides a useful and concrete result of performing identity data enhancement operations.

FIG. 2 is a simplified block diagram of an identity data enhancement process implemented in accordance with an embodiment of the invention. In certain embodiments, enhanced trait cross-reference (ETX) operations 202, described in greater detail herein, are performed on an original 204 identity dataset to generate an enhanced matched 216 identity dataset corresponding to a particular context. In certain embodiments, the ETX operations 202 may include the transformation of an original 204 identity dataset into a classified 206 identity dataset, which in turn may be transformed into an enhanced 208 identity dataset. In certain embodiments, the ETX operations 202 may likewise include the transformation of the enhanced 208 identity dataset into a matched 212 identity dataset, which in turn may be transformed into an enhanced matched 216 identity dataset.

In certain embodiments, an ETX 210 dataset may be used to transform the classified 206 identity dataset into the enhanced 208 identity dataset. Likewise, a reference 214 dataset may be used in certain embodiments to transform the enhanced identity 208 dataset into matched 212 identity dataset. In certain embodiments, an ancillary 218 dataset may be used to transform the matched 212 identity dataset into an enhanced matched 216 identity dataset.

As used herein, identity data broadly refers to any data that can be used, individually or in combination with other data, to uniquely identify an entity. As likewise used herein, an entity broadly refers to an individual person, a group, an organization, or a physical thing, such as a building or venue. Examples of identity data include a name, an honorific, a gender classification, a profession, an employer, a company, an organizational affiliation, a position, a military rank, a business or academic title, and a certification.

Other examples of identity data include a biometric, a government identification number, a proprietary or non-proprietary reference identifier (ID), a physical address, a network address, an email address, a social media identity, a telephone number, and a device ID. Likewise, examples of proprietary reference IDs include a database record identifier, an account number (e.g., bank account, debit or credit card, department store or commercial account, etc.), an employee number, and a software license serial number. Examples of non-proprietary reference IDs include national identifiers, such as a Social Security Number, a Taxpayer ID number, a corporate identifier, such as a Securities Exchange Commission (SEC) number, and a Legal Entity Identifier (LEI). Likewise, examples of device IDs include a hardware serial number, a Vehicle Identification Number (VIN), an International Mobile Equipment Identity (IMEI) number, a Unique Device ID (UDID), an Electronic Serial Number (ESN), and a Central Processor Unit (CPU) ID. Skilled practitioners of the art will be knowledgeable of many such examples of identity data. Accordingly, the foregoing is not intended to limit the spirit, scope or intent of the invention.

As likewise used herein, a dataset broadly refers to a collection of data, and its associated data elements, attributes, and metadata, regardless of how it may be formatted, organized or stored. As an example, the collection of data may be structured, unstructured, or a combination thereof. Examples of datasets include a document, a flat text file, a delimiter-separated file, a spreadsheet, a relational database, an object database, a columnar database, a Not Only Structured Query Language (NoSQL) database, a graph database, a probabilistic database, a temporal database, and other collections of data familiar to those of skill in the art.

Likewise, as used herein and as it relates to identity data, a context broadly refers to an intended use of the identity data. In certain embodiments, the context may refer to the intent to use the identity data for marketing purposes. As an example, a company's or person's name and physical address may be used for a direct mail campaign. As another example, a company's or person's name and telephone number may be used for a telemarketing campaign. As yet another example, a person's email address may be used for an email campaign. As yet still another example, a person's profession, title, position, certification, and so forth, may be used individually or in combination to more accurately target a particular entity, such as a company or other organization, for the purpose of various marketing activities.

In certain embodiments, the context may refer to certain demographics, market segments, industries, professions, affiliations, geographies, or types of transactions. As an example, a person's profession may be used in combination with their employer's physical address to determine the density of individuals in different professions within certain geographical boundaries. As another example, the intended use of the identity data may be in the context of a business-to-business (B2B), business-to-consumer (B2C), or peer-to-peer (P2P) transaction. In certain embodiments, such transactions may be related to one or more marketing activities.

In certain embodiments, the intended use of the identity data may be in the context of certain business processes or operations. As an example, an individual user's identity data may be used to facilitate certain Customer Relationship Management (CRM) functions to improve efficiency and customer satisfaction. As another example, certain identity data related to individual customers, and their associated organizations, may be used to not only reconcile and rationalize individual customer records spread across multiple data silos, but to aggregate and normalize such data into a standardized customer profile. Skilled practitioners of the art will be knowledgeable of many such examples of identity data being related to a particular context. Accordingly, the foregoing is not intended to limit the spirit, scope or intent of the invention.

In certain embodiments, an original 204 identity dataset is received for processing. Once received, certain classification operations are performed on the original 204 identity dataset to identify data attributes associated with a particular context it may contain. As used herein, a data classification operation broadly refers to empirically observing the contents of a dataset and surmising what kind(s) of data it may contain. As an example, the original 204 dataset may include a relational database containing a plurality of records, each of which contains the same fields. In certain embodiments, the original 204 dataset is processed such that a particular type of identity data can be inferred for each field. To continue the example, one such field may contain numerical identity data in the format of “99999-9999,” which may be inferred to be a ZIP code respectively associated with each record.

In certain embodiments, the classification operations may include the use of a classifier. As used herein, a classifier broadly refers to a method of identifying a particular data attribute associated with a context. Examples of such classifiers include honorifics and titles, names, physical and network addresses, telephone numbers, email addresses, social media identifiers, industries, organizations, professions, statistics and other numerical data, colors and textures, and so forth. Those of skill in the art will recognize that many such examples of classifiers are possible. Accordingly, the foregoing is not intended to limit the spirit, scope or intent of the invention.

As an example, a context may be the intent to use identity data for an integrated marketing campaign with the goal of encouraging physicians to recommend certain durable medical equipment (DME). In this example, the integrated marketing campaign may include direct mail, email, social media, telephone contact, and face-to-face presentations. To continue the example, the original 204 identity dataset may contain unstructured text that includes a passage stating, “Dr. Rob Smith is a surgeon with Austin Surgery Associates.”

In this example, identified data attributes may include a name (e.g., Dr. Rob Smith), a profession (e.g., surgeon), and a company name (e.g., Austin Surgery Associates). Data classification operations are then performed on the resulting data attributes to generate discrete data elements. In continuance of the example, the data attribute of the name “Dr. Rob Smith” may be classified into the discrete data elements of “Dr.,” “Rob,” and “Smith.” The resulting discrete data elements are then mapped to classified identity data attributes. As used herein, a classified identity data attribute broadly refers to an attribute that may be used in certain embodiments to generate an enhanced matched 216 identity dataset, described in greater detail herein, according to a particular format or structure.

For example, the discrete data element of “Dr.” may be mapped to the classified identity data attribute of “Title.” Likewise, the discrete data elements of “Rob” and “Smith” may be respectively mapped to the classified identity data attributes of “First Name” and “Last Name.” To continue the example, the discrete data elements of “surgeon” and “Austin Surgery Associates” may likewise be respectively mapped to the classified identity data attributes of “Profession” and “Company.” In certain embodiments, the classified identity data attributes used for mapping such discrete data elements, and their associated nomenclature, are a matter of design choice. In certain embodiments, the classified identity data attributes used for the mapping may correspond to the context of the identity data.

The resulting classified identity data attributes are then processed to generate a classified 206 identity dataset. As used herein a classified 206 identity dataset broadly refers to a collection of classified identity data attributes corresponding to a particular context. In certain embodiments, the method by which the classified identity data attributes are formatted, structured, and organized is a matter of design choice.

In certain embodiments, the resulting classified 206 identity dataset may then be processed with an enhanced trait cross-reference (ETX) 210 dataset to generate an enhanced 208 identity dataset. As used herein, an ETX 210 dataset broadly refers to a set of data that may be used in certain embodiments, directly or indirectly, to generate additional, or revise existing, identity data. In various embodiments, the ETX 210 dataset may include a classified identity data attribute in common with the classified 206 identity dataset. However, in certain embodiments the ETX 210 dataset may include certain classified identity data attributes that are not present in the classified 206 dataset. In certain embodiments, these additional classified identity data attributes may be appended to the classified 206 identity dataset to transform it into an enhanced 208 identity dataset.

As an example, the classified 206 identity dataset may include a classified identity data attribute of “phone number,” which is likewise present in the ETX 210 dataset. However, the ETX 210 dataset may also have a classified identity data attribute of “service type,” which may indicate whether a particular phone number is associated with a landline or a mobile device. Likewise, the ETX 210 dataset may additionally have a classified data attribute of “carrier,” signifying the telecommunications service provider that the phone number is associated with. Accordingly, the classified 206 identity dataset in this example may be appended to include the type of service, and the service provider, for various phone numbers that are present in both the classified 206 and ETX 210 identity datasets.

As likewise used herein, a trait broadly refers to a characteristic of a data element that may not be immediately apparent. In certain embodiments, such a data element may be a classified identity data attribute. In certain embodiments, the ETX 210 dataset may be used in various ETX operations 202 to process such traits to derive, or infer, one or more classified identity data attributes. In certain embodiments, these derived or inferred classified identity data attributes may be used to augment, or revise, the classified 206 identity dataset to generate an enhanced 208 identity dataset. Accordingly, as used herein, an enhanced 208 identity dataset broadly refers to a classified 206 identity dataset that has been further enhanced with a collection of extended or inferred classified identity data attributes.

As an example, the classified 206 identity dataset may have classified identity dataset attributes that include an individual's first and last name, as well as a telephone number, but not a street address, city or state. In this example, a first set of ETX data in the ETX 210 dataset may include a list of telephone numbers, whether they are a mobile or land line number, and their associated service providers. Likewise, a second set of ETX data in the ETX 210 dataset may include a particular telephone service provider's billing database.

To continue the example, the telephone number contained in the classified 206 identity dataset can be used to query the first set of ETX data in the ETX 210 dataset to determine the telephone number's associated service provider and whether it is for a mobile device or a land line. Once the service provider is determined, the telephone number can then be used to query the second set of ETX data in the ETX 210 dataset to determine the individual's name and billing address. The resulting ETX data results can then be used to validate the individual's first and last name in the classified 206 identity data set, as well as appending their address information and the type of service associated with the telephone number.

In certain embodiments, the ETX 210 dataset may be used to provide a more accurate, or preferred, depiction or description of a classified identity data attribute in an enhanced 208 identity dataset. For example, a contiguous street, road, highway or other thoroughfare may be variously known by different names at different locations along its route. To continue the example, Highway 290, 51^{st} Street, Koenig Lane, Allandale Road, and RM2222 are all the same thoroughfare in Austin, Tex. However, “2705 Allandale Road” may be a more accurate, or accepted, description of an address than “2705 Koenig Lane.” In certain embodiments, the ETX 210 dataset may be centralized in a single data store, distributed across multiple data stores, or provided as a service. Skilled practitioners of the art will recognize that many such examples of an ETX 210 dataset, and its associated use to transform a classified 206 identity dataset into an enhanced 208 identity dataset, are possible. Accordingly, the foregoing is not intended to limit the spirit, scope or intent of the invention.

In certain embodiments, the enhanced 208 identity dataset is then processed to generate a matched 212 identity dataset. As used herein, a matched 212 identity dataset broadly refers to collections, or sets, of classified identity data attributes deemed to be sufficiently validated, or matched, against a reference 214 dataset for a use related to a particular context. As an example, an enhanced 208 identity dataset may include classified data identity attributes for a person's name and email address, yet not have their associated phone number. Consequently, the enhanced 208 identity dataset would be deemed insufficiently validated for use in a telemarketing campaign. However, the person's name and email address may provide sufficient information to find a match in the reference 214 dataset, which may contain the missing phone number. Accordingly, the reference 214 dataset could be used to augment the enhanced 208 identity dataset with the person's phone number, and as a result, generate a matched 212 identity dataset suitable for use in the telemarketing campaign.

In various embodiments, the reference 214 dataset may include reference identifiers respectively associated with corresponding reference data records, which in turn may include certain identity data associated with an entity. As used herein, a reference identifier broadly refers to a unique identifier associated with a certain subset of classified identity data attributes respectively contained in the reference 214 identity dataset. In certain embodiments, the reference identifier may be implemented as an open global identifier. As likewise used herein, an open global identifier broadly refers to a unique, non-proprietary identifier associated with an individual set of data contained in the reference 214 dataset. In certain embodiments, an open global identifier may be implemented to cross-reference, or otherwise index, a proprietary reference identifier associated with a set of data contained in an original 204 or ancillary 218 dataset.

In certain embodiments, one or more reference identifiers may be identified in the enhanced 208 identity dataset. If so, then they may be used in certain embodiments to search a reference 214 dataset to determine whether it contains the same reference identifier(s). If so, then any identity data associated with the reference identifier(s) within the reference 214 dataset is retrieved. The retrieved identity data is then processed with enhanced 208 identity dataset to determine whether there is a sufficient match. If so, then the identity data retrieved from the reference 214 dataset may be processed with the enhanced 208 identity dataset in certain embodiments to generate a matched 212 identity dataset.

However, it may be determined that that there is an insufficient match between the identity data retrieved from the reference 214 dataset and the enhanced 208 identity dataset. As an example, the reference identifier contained in the enhanced 208 identity dataset may match a reference identifier contained in the reference 214 dataset, yet no other classified identity data attributes match. One possibility for such a miss-match is the reference identifier in the enhanced 208 identity dataset may have been entered incorrectly, or possibly truncated during various data extraction, parsing, classification or transformation operations.

In certain embodiments, determining the degree of the matching is performed probabilistically. As an example, each identity data attribute may be assigned a numerical value of “10.” In this example, if 7 out of the 10 identity data attributes match, then a score of “700” may be calculated, equating to a probabilistic value of “70%.” Likewise, if 2 out of 3 identity data attributes match, then a probability value of “66%” may be calculated. It will be appreciated that the larger the number of identity data attributes used for matching, and the higher the number of associated matches, the more likely it will be that the probability value will reflect the accuracy of the match.

As another example, the first and last name attributes associated with an individual, as well as the city and state identity data attributes may match, yet the address and telephone number classified identity data attributes may not. Accordingly, the degree of not matching may fall beneath a defined threshold level, and by extension, indicate the identity data may not be associated with the same entity. In certain embodiments, the defined threshold level is a matter of design choice.

If it is determined that the degree of match between the classified identity data attributes respectively associated with the enhanced 208 identity dataset and the reference 214 dataset is below the defined threshold level, then the enhanced 208 identity dataset is processed to identify the closest-matching subset of identity data in the reference 214 dataset. In certain embodiments, the threshold value may be calculated. In these embodiments, the method by which the threshold value is calculated is a matter of design choice. In certain embodiments, the threshold value may be manually selected, or otherwise defined, by a user. In certain embodiments, the threshold value may vary dynamically, depending upon the distribution of match probabilities between the enhanced 208 identity dataset and the reference 214 dataset.

In certain embodiments, only a single closest-matching subset of identity data, such as an individual data record, may be identified. In various embodiments, a plurality of close-matching subsets of identity data may be identified. In certain of these embodiments, the degree to which each of these subsets of identity data match the enhanced 208 identity dataset may be represented by an associated probabilistic value. In certain embodiments, the closest-matching subsets of identity records may be ranked according to their associated probabilistic values. In these embodiments, the method by which the probabilistic value is determined, and their associated ranking, is a matter of design choice.

In certain embodiments, it may be possible that no closest-matching subset of identity data is present in the reference 214 dataset for a particular enhanced 208 identity dataset record. However, it may be possible that the enhanced 208 identity dataset record may be sufficiently populated to be considered substantively complete. For example, the enhanced 208 identity dataset record may include a company name and physical address, as well as a particular employee's contact information, including their phone numbers and email address. In certain embodiments, a unique reference identifier may be generated and associated with such an enhanced 208 identity dataset record, which in turn may then be added to the reference 214 dataset. In certain embodiments, such an approach allows the creation of an initial reference 214 dataset from an associated enhanced 208 identity dataset.

In certain embodiments, the transformation of an enhanced 208 identity dataset to a matched 212 identity dataset may include the matching of individual enhanced data records contained in the enhanced 208 identity dataset to corresponding reference data records contained in the reference 214 dataset. In certain embodiments, the unique global identifier corresponding to a matched reference data record contained in the reference 214 dataset may be associated with a corresponding enhanced 208 identity dataset record. In certain embodiments, the selection of the reference 214 dataset used to generate the matched 212 dataset is matter of design choice. In certain embodiments, the reference identifiers corresponding to a certain identity data present in a first reference 214 dataset may be different than the reference identifier corresponding to the same identity data present in a second reference 212 dataset. In certain embodiments, the reference identifiers corresponding to certain identity data present in both a first and second reference 214 dataset may be the same.

In certain embodiments, the reference identifiers corresponding to a first subset of identity data present in both a first and second reference 214 dataset may be the same, yet they may each contain a second subset of identity data that is not the same. As an example, the first subset of information may include a company's name and physical address, which respectively are associated with the same reference identifiers in both the first and second reference 214 datasets. However, the first reference 214 dataset may have a second subset of identity data that includes employee's names and their corresponding email addresses. Likewise, the second reference 214 dataset may have a second subset of identity data that includes employee's names and their corresponding phone numbers. Accordingly, the common reference identifiers may be used in certain embodiments to generate a more complete matched 212 dataset that includes a company's name and their physical address, along with a composite list of employees and their respective email address and phone numbers.

In certain embodiments, the resulting matched 212 dataset may be implemented as a single, aggregated dataset. In certain embodiments, the matched 212 dataset may be implemented as a virtual dataset. To continue the preceding example, reference identifiers present in the matched 212 dataset are used to cross-reference, or otherwise index, certain identity data present in the first and second reference 214 datasets that is associated with the same reference identifiers. Skilled practitioners of the art that many such embodiments of the use of such reference identifiers to cross-reference, or otherwise index, identity data associated with matched 212 and reference 214 datasets are possible. Accordingly, the foregoing is not intended to limit the spirit, scope or intent of the invention.

In certain embodiments, certain ETX operations 202 are performed on the matched 212 identity dataset to generate an enhanced matched 216 identity dataset. As used herein, an enhanced matched 216 identity dataset broadly refers to a matched 212 identity dataset that has been augmented, or revised, with ancillary data to improve its usefulness for a use related to a particular context. In certain embodiments, the ancillary data may be contained in an ancillary 218 dataset. As used herein, ancillary data broadly refers to any previously-created matched 212 identity dataset that may not be contained in the original 204, ETX 210, or reference 214 dataset.

As an example, the ancillary 218 dataset may include data corresponding to medical equipment in use at different medical facilities. In this example, the transformation of the original 204 dataset to a matched 212 identity dataset may provide validated contact information associated with a group of medical professionals, but not the medical equipment that may be deployed at their respective places of employment. Consequently, the addition of ancillary data to a matched 212 identity dataset would likely provide meaningful and valuable information for use in a marketing campaign, customer relationship management (CRM), or product support.

In various embodiments, the use of the ancillary 218 dataset for augmentation or revision of certain identity data contained within the matched identity 212 dataset may involve data normalization and rationalization operations familiar to those of skill in the art. Skilled practitioners will recognize that many such embodiments and examples are possible. Accordingly, the foregoing is not intended to limit the spirit, scope, or intent of the invention.

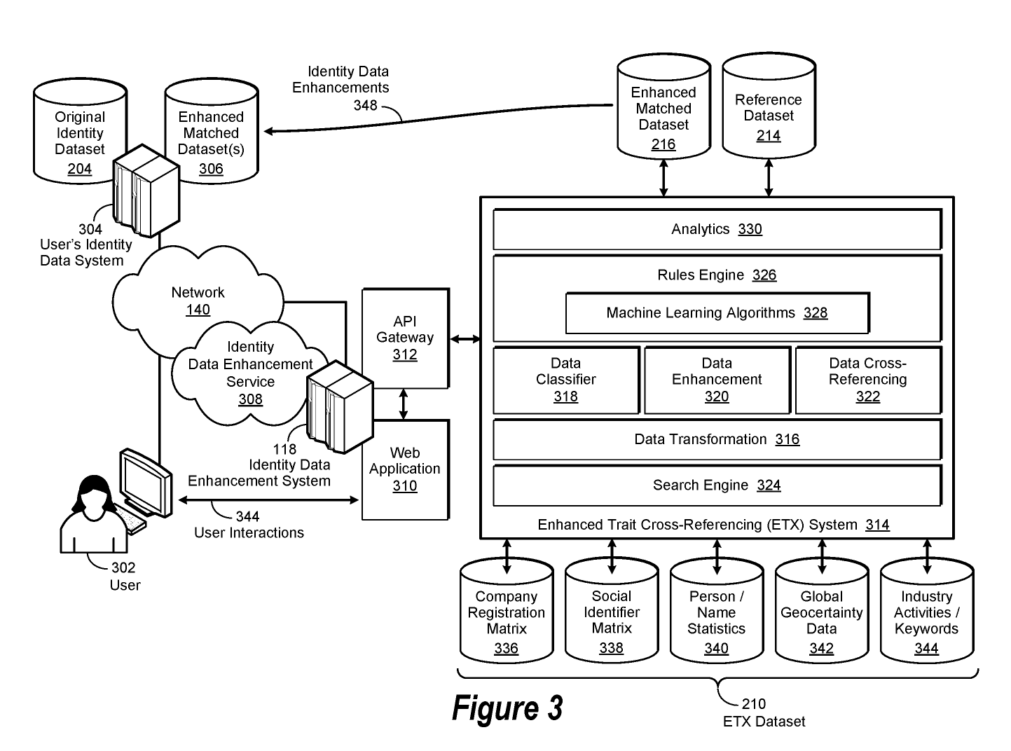

FIG. 3 is a simplified block diagram of the operation of an identity data enhancement system implemented in accordance with an embodiment of the invention. In certain embodiments, an identity data enhancement system 118 may be implemented to transform an original 204 identity dataset into an enhanced matched 216 identity dataset corresponding to a particular context, as described in greater detail herein. In certain embodiments, the identity data enhancement system 118 may be implemented as an identity data enhancement service 308. In certain embodiments, the identity data enhancement service 308 may be provided via a network 140.

In certain embodiments, the identity data enhancement system 118 may include a web application 310, an Application Program Interface (API) gateway 312, and an enhanced trait cross-referencing (ETX) system 314. In certain embodiments, the web application 310 may be implemented to allow a user 302 to have user interactions 344 with the identity data enhancement system 118. In certain embodiments, the user interactions 344 are performed via a network 140 communication.

In certain embodiments, the API gateway 312 may be implemented to allow the user's identity data system 304 to interact directly, or indirectly, with the identity data enhancement system 118. In certain embodiments, the direct or indirect interactions are performed via a network 140 communication. In certain embodiments, the user's identity data system 304 may include repositories of original 204 identity datasets and one or more enhanced matched 306 identity datasets.

In certain embodiments, the API gateway 312 may be implemented to provide access to the ETX system 314. In certain embodiments, the web application 310 may be implemented to access the ETX system 314 via the API gateway 312. In certain embodiments, the ETX system 314 may include a data transformation 316 module, a data classifier 318 module, a data enhancement 320 module, a data cross-referencing 322 module, a rules engine 326, an analytics 330 module, and a search engine 324, or a combination thereof. In certain embodiments, the rules engine 326 may include machine learning algorithms 328, which are implemented by the rules engine 326 to automatically generate rules used in the performance of various ETX operations.

In certain embodiments, the data classifier module 318 may be implemented to perform various identity dataset classification operations, described in greater detail herein, to generate a classified identity dataset. In certain embodiments, the data enhancement module 320 may be implemented to perform various ETX operations associated with the generation on an enhanced identity dataset, as likewise described in greater detail herein. In certain embodiments, the data cross-referencing module 322 may be implemented to perform various ETX operations associated with the generation of matched identity dataset.

As used herein, cross-referencing broadly refers to determining the degree two datasets, or subsets thereof, are similar to one another. In certain embodiments, the two datasets may be formatted, structured, or organized differently. In certain embodiments, the cross-referencing is performed to determine whether two datasets, or subsets thereof, refer to the same entity. In certain embodiments, the data cross-referencing module 322 may likewise be implemented to perform various ETX operations associated with the generation of matched and enhanced matched identity datasets, described in greater detail herein.

In certain embodiments, an original 204 identity dataset may be provided to the identity data management system 118 for transformation into an enhanced matched 216 identity dataset corresponding to a particular context, as described in greater detail herein. In certain embodiments, various ETX operations, likewise described in greater detail herein, are performed on the original 204 identity dataset to transform the original 204 identity dataset into a classified identity dataset. In certain embodiments, additional ETX operations may be performed to transform the classified identity dataset into matched identity dataset.

In certain embodiments, an enhanced trait cross-reference (ETX) 210 dataset may be used to transform the classified identity dataset into the enhanced identity dataset, as described in greater detail herein. Likewise, a reference 214 dataset may be used in certain embodiments to transform the enhanced identity dataset into a matched identity dataset, as likewise described in greater detail herein. In certain embodiments, the ETX 210 dataset may include company registration matrix 336 data, social media identifier matrix 338 data, person/name statistics 340 data, global geocertainty 342 data, and industry/activities keyword 344 data, or a combination thereof.

In certain embodiments, the data transformation module 316 may be implemented to transform certain data in the ETX 210 dataset and the reference 214 dataset, into a form suitable for the performance of ETX operations. In certain embodiments, the data transformation module 316 may be implemented to transform identity data residing in the enhanced matched 216 identity dataset into the form of identity data enhancements 348. In certain embodiments, the identity data enhancements 348 may be provided to the user's identity data system 304 in a form suitable for use in the repository of enhanced matched 306 datasets.

In certain embodiments, the search engine 324 is implemented to perform various ETX operations associated with probabilistic matching of certain subsets of a classified identity dataset to subsets of the reference 214 dataset. In certain embodiments, the search engine 324 may likewise be implemented to perform various ETX operations associated with cross-referencing certain subsets of a classified identity dataset with various ETX 210 dataset. In certain embodiments, the analytics module 330 may be implemented to provide statistical analysis associated with the performance of various ETX operations and to analyze the contents of a dataset for a particular context. In certain embodiments, the analytics module 330 may be implemented to define acceptable identity matching threshold levels, described in greater detail herein. In certain embodiments, the analytics module 330 may be implemented for user interactions 344 through a web application 310.

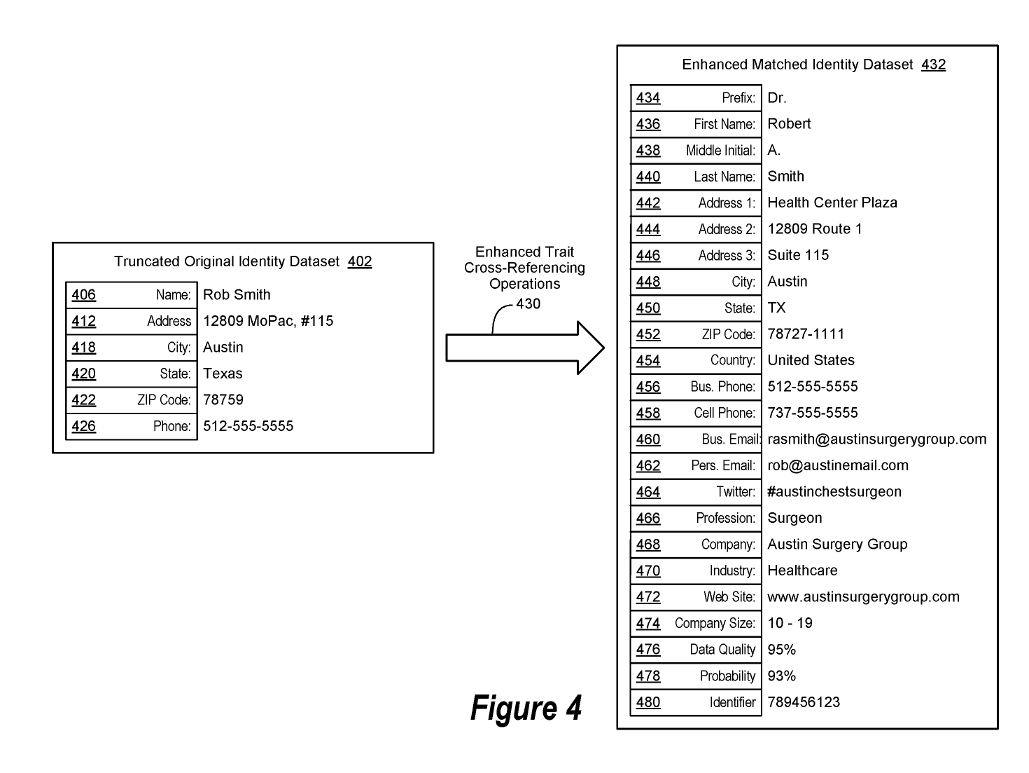

FIG. 4 is a simplified block diagram of the transformation of a truncated original identity dataset into an enhanced matched identity dataset implemented in accordance with an embodiment of the invention. Certain embodiments of the invention reflect an appreciation that an individual or organization may possess an original identity dataset that may be incomplete, contain incorrect or non-optimally structured information, or a combination thereof. Certain embodiments of the invention likewise reflect an appreciation that such individuals or organizations may desire to enhance such an original identity dataset to improve its completeness, accuracy and usability.

In certain embodiments, enhanced trait cross-referencing (ETX) operations 430 may be performed on a truncated original identity dataset 402 to generate an enhanced matched 432 identity dataset. As shown in FIG. 4, the truncated original identity dataset 402 includes data elements First Name 406, Address 1 412, City 418, State 420, ZIP Code 422, and Bus. Phone 426, which respectively have associated attributes of “Rob Smith,” “12809 MoPac, #115,” “Austin,” “TX,” “78759,” and “512-555-5555.” As a result of the performance of ETX operations 430, a resulting enhanced matched identity dataset 432 is generated, which includes a First Name 436 data element with an attribute of “Robert,” and a Last Name 438 data element with an attribute of “Smith.” As an example, the ETX operations 430 may include data classification operations, which parse the Name 406 data element with an attribute of “Rob Smith” into the classified identity data attributes of “Rob” and “Smith.”

To continue the example, further ETX operations 430 are then performed to use the resulting classified identity data attributes of “Rob” and “Smith,” in combination with data element Address 412, City 418, State 420, ZIP Code 422, and Bus. Phone 426, which respectively have associated attributes of “12809 MoPac, #115,” “Austin,” “Texas,” “78759,” and “512-555-5555,” to query a reference dataset. As a result of these additional ETX operations 450, the enhanced matched identity dataset 432 now includes data elements Prefix 434, First Name 436, Middle Initial 438, and Last Name 440, which respectively have associated attributes of “Dr.,” “Robert,” “A.,” and “Smith.” Skilled practitioners of the art will appreciate that the addition of attributes associated with the Prefix 434 and Middle Initial 438, combined with the revised attribute associated with the First Name 436 data element advantageously provides a more complete and formal name and title.

Likewise, further ETX operations 430 can use the attribute “12809 MoPac, #115” associated with data element Address 412 to query a reference dataset to provide a more accurate and complete address. Accordingly, the enhanced matched identity dataset 432 now also includes data elements Address 1 442, Address 2 444, Address 3 446, City 448, State 450, ZIP Code 452, and Country 454, which respectively have attributes of “Health Center Plaza,” “12809 Route 1,” “Suite 115,” “Austin,” “TX,” “78727-1111,” and “United States.” Those of skill in the art will likewise appreciate having a location name associated with a street address, as well as a corrected and extended ZIP code, advantageously provides more complete and accurate address information.

Further ETX operations 430 can likewise use the attributes respectively associated with data elements First Name 406, Address 1 412, City 418, State 420, ZIP Code 422, and Bus. Phone 426 to query a reference dataset for additional identity information. For example, the enhanced matched 432 identity dataset now also includes Cell Phone 458, Bus. Email 460, Pers. Email 462, Twitter 464, Profession 466, Company 468 Industry 470, Web Site 472, and Company Size 474 data elements. As show in FIG. 4, these data elements are respectively associated with attributes “737-555-5555,” “rasmith@austinsurgerygroup.com,” “rob@austinemail.com,” “#austinchestsurgeon,” “Surgeon,” “Austin Surgery Group,” “Healthcare,” “www.austinsurgerygroup.com,” and “10-19.” Likewise, as a result of the performance of additional ETX operations 430, described in greater detail herein, the enhanced matched 432 identity dataset now also includes a Data Quality 476 and a Probability 476 data element with respective attributes of “95%” and “93%,” which indicate a degree of completeness and accuracy. In addition, the matched 432 identity dataset likewise now has a unique reference Identifier data element 480 with the attribute “789456123.”

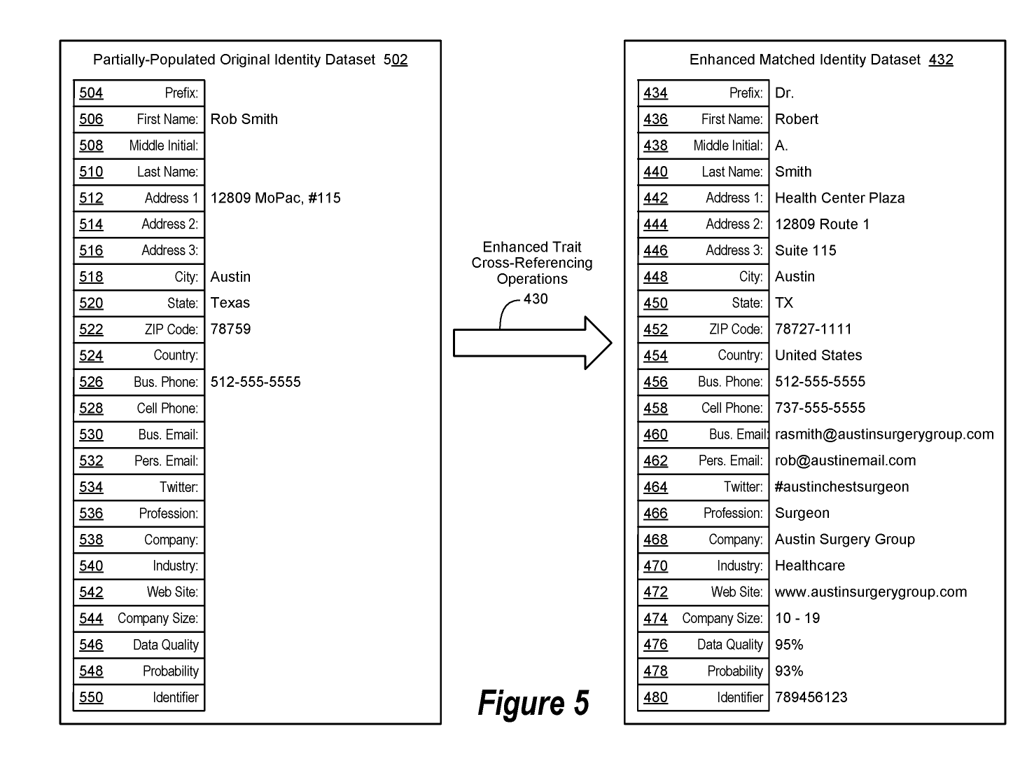

FIG. 5 is a simplified block diagram of the transformation of a partially populated original identity dataset into an enhanced matched identity dataset implemented in accordance with an embodiment of the invention. In certain embodiments, enhanced trait cross-referencing (ETX) operations 430 may be performed on an partially-populated original 502 identity dataset to generate an enhanced matched 432 identity dataset. As shown in FIG. 5, the partially populated original 502 identity dataset includes data elements First Name 506, Address 1 512, City 518 State 520 and ZIP Code 522, and Bus. Phone 526, which respectively have associated attributes of “Rob Smith,” “12809 MoPac, #115,” “Austin,” “TX,” “78759,” and “512-555-5555.” As likewise shown in FIG. 5, the partially populated original 502 identity dataset also includes data elements Prefix 504, Middle Initial 508, Last Name 510, Address 2 514, Address 3 516, Country 524, Pers. Phone 528, Bus. Email 530, Pers. Email 532, Twitter 534, Profession 536, Company 538, Industry 540, Web Site 542, Company Size 544, Data Quality 546, Probability 548, and Identifier 550, none of which have associated attributes.

As a result of the performance of ETX operations 430, a resulting enhanced matched 432 identity dataset is generated, which includes a First Name 436 data element with an attribute of “Robert,” and a Last Name 440 data element with an attribute of “Smith.” As described in the descriptive text associated with FIG. 4, further ETX operations 430 are then performed to use the resulting classified identity data attributes of “Rob” and “Smith,” in combination with data element Address1 512, City 518, State 520, ZIP Code 522, and Bus. Phone 526, which respectively have associated attributes of “12809 MoPac, #115,” “Austin,” “Texas,” “78759,” and “512-555-5555,” to query a reference dataset. As a result of these additional ETX operations 130, the enhanced matched identity dataset 432 now includes data elements Prefix 434, First Name 436, Middle Initial 438, and Last Name 440, which respectively have associated attributes of “Dr.,” “Robert,” “A.,” and “Smith.”

As likewise described in the descriptive text associated with FIG. 4, further ETX operations 430 can use the attribute “12809 MoPac, #115” associated with data element Address 1 512 to query a reference dataset to provide a more accurate and complete address. Accordingly, the enhanced matched 432 identity dataset now also includes data elements Address 1 442, Address 2 444, Address 3 446, City 448, State 450, ZIP Code 452, and Country 454, which respectively have attributes of “Health Center Plaza,” “12809 Route 1,” “Suite 115,” “Austin,” “TX,” “78727-1111,” and “United States.”

Further ETX operations 430 can likewise use the attributes respectively associated with data elements First Name 506, Address 1 512, City 518, State 520, ZIP Code 522, and Bus. Phone 526 to query a reference dataset for additional information. For example, the enhanced matched identity dataset 432 now also includes Cell Phone 458, Bus. Email 460, Pers. Email 462, Twitter 464, Profession 466, Company 468 Industry 470, Web Site 472, and Company Size 494 data elements. As show in FIG. 5, these data elements are respectively associated with attributes “737-555-5555,” “rasmith@austinsurgerygroup.com,” “rob@austinemail.com,” “#austinchestsurgeon,” “Surgeon,” “Austin Surgery Group,” “Healthcare,” “www.austinsurgerygroup.com,” and “10-19.” Likewise, as a result of the performance of additional ETX operations 130, described in greater detail herein, the enhanced matched identity dataset 432 now also includes a Data Quality 476 and a Probability 476 data element with respective attributes of “95%” and “93%,” which indicate a degree of completeness and accuracy. In addition, the matched 432 identity dataset likewise now has a unique reference Identifier data element 480 with the attribute “789456123.”

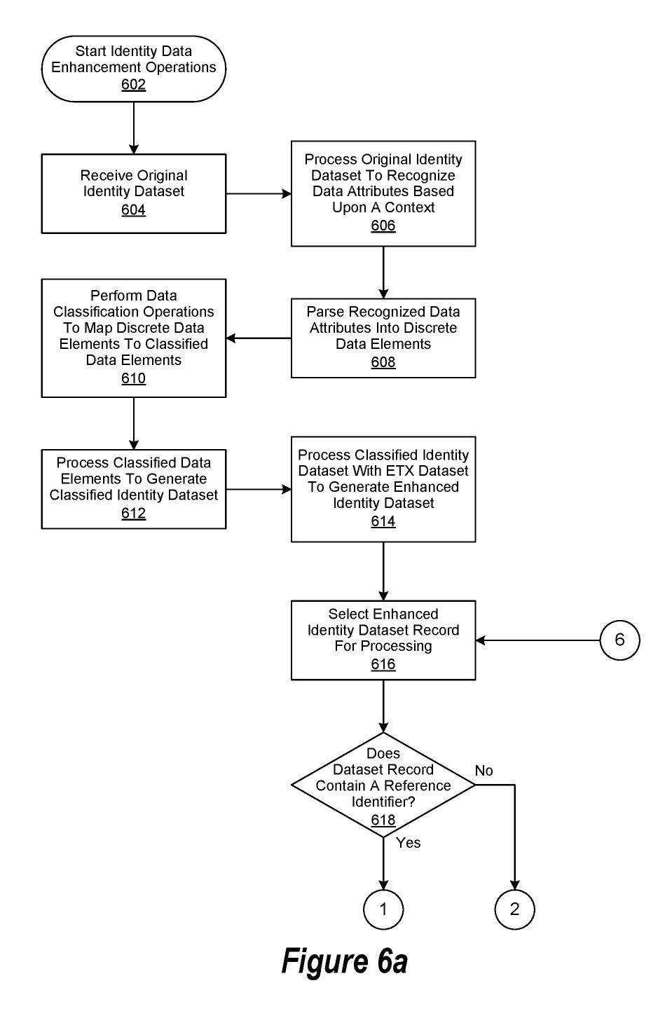

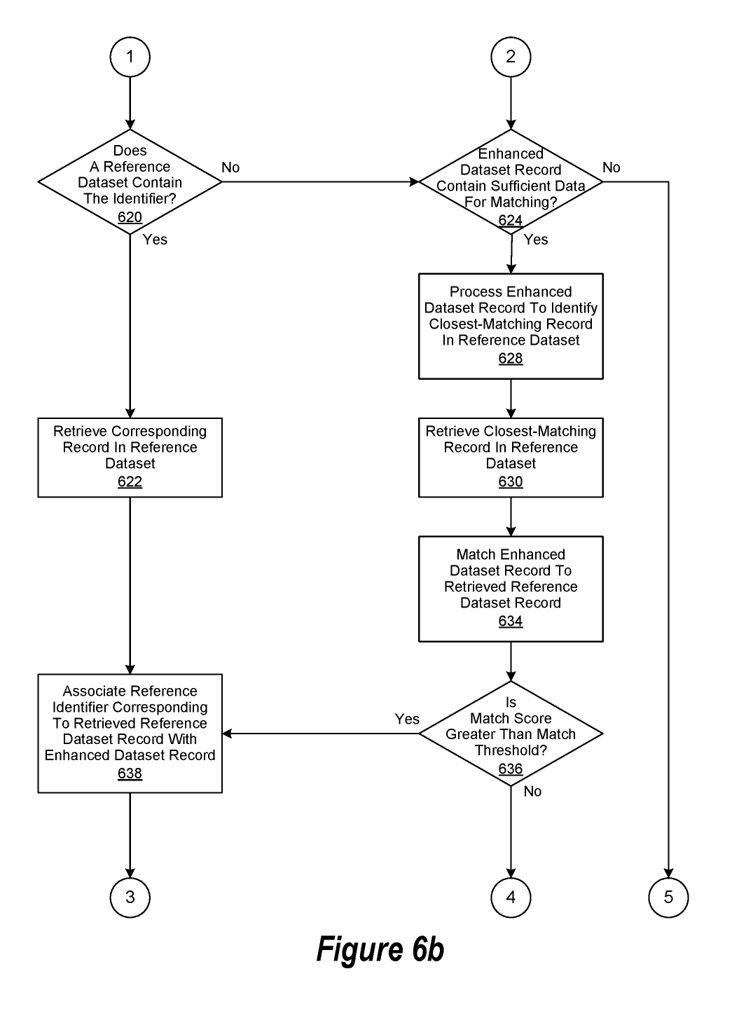

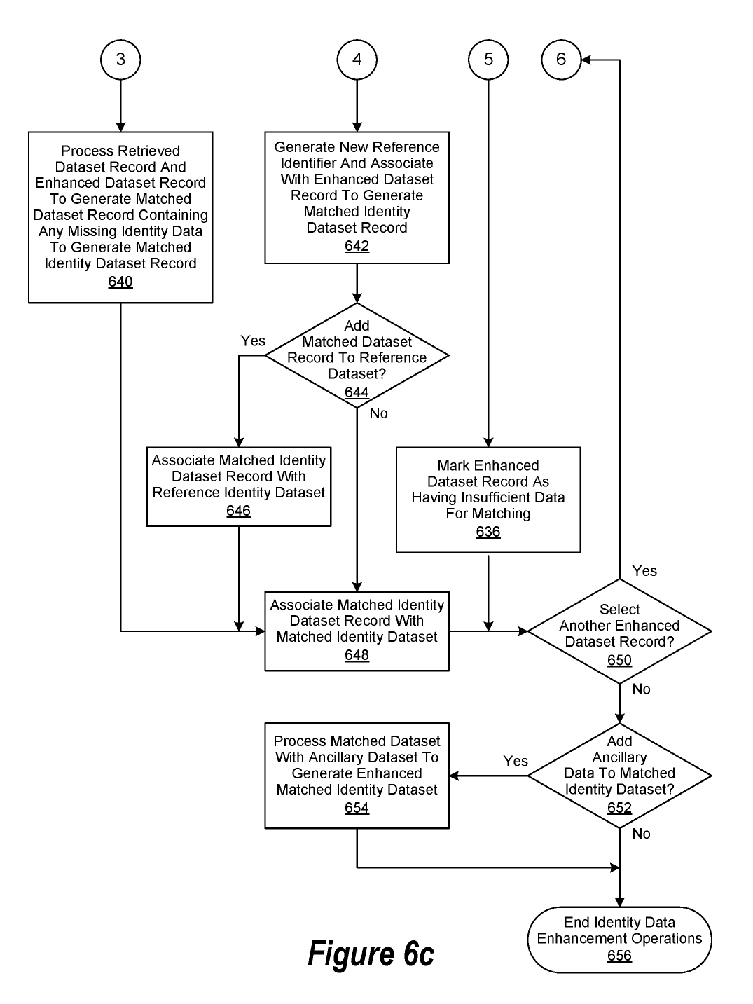

FIGS. 6a through 6c are a generalized flowchart of the performance of automated identity data management operations. In certain embodiments, an original identity dataset, described in greater detail herein, is processed to generate an enhanced probabilistic identity dataset. In this embodiment, identity data enhancement operations are begun in step 602, followed by the receipt of an original identity dataset in step 604. The original identity dataset is then processed in step 606 to recognize its associated attributes, based upon a context, described in greater detail herein. The resulting data attributes are then parsed into discrete data elements in step 608, followed by data classification operations, likewise described in greater detail herein, being performed in step 610 on the resulting discrete data elements to generate classified data elements.

The classified data elements are then processed in step 612 to generate a classified identity dataset, described in greater detail herein, which in turn is processed in step 614 with an enhanced trait cross-reference (ETX) dataset, likewise described in greater detail herein, to generate an enhanced identity dataset. An enhanced dataset record is then selected in step 616, followed by a determination being made in step 618 whether it contains a unique reference number. If so, then a determination is made in step 620 whether a reference dataset, described in greater detail herein, contains the reference identifier. If so, then the corresponding record in the reference dataset is retrieved in step 622.

However, if it was determined in step 618 that the enhanced dataset record does not contain a unique reference identifier, then a determination is made in step 624 whether it contains sufficient data for matching to the reference dataset. If not, then the enhanced dataset record is marked as having insufficient data for matching in step 626. Otherwise, the enhanced dataset record is processed in step 628 to find the closest-matching record in the reference dataset, which is then retrieved in step 630. Matching operations, described in greater detail herein, are then performed in step 634 to compare the retrieved reference dataset record to the enhanced dataset record, followed by a determination being made in step 636 whether the resulting match score is exceeds a particular match score. If so, or once the reference dataset record is retrieved in step 622, then the reference identifier associated with the retrieved reference dataset record is associated with the enhanced dataset record in step 638.

However, if it was determined in step 636 that the resulting match score did not exceed a particular match score threshold, then a new unique reference identifier is generated and associated with the enhanced dataset record in step 642 to generate a matched identity dataset record. A determination is then made in step 644 whether to add the resulting matched identity dataset record to the reference dataset. If so, then the matched identity dataset record is associated with the reference dataset in step 646. Otherwise, or once the matched identity dataset record is generated in step 640, or once the matched identity dataset record has been associated with the reference dataset in step 646, the matched identity dataset record is matched with a target matched identity dataset in step 648.

A determination is then made in step 650 whether to select another enhanced dataset record for processing. If so, then the process is continued, proceeding with step 616. Otherwise, a determination is made in step 652 whether to add ancillary data, described in greater detail herein, to a target matched identity dataset. If so, then the target matched identity dataset is processed with a target ancillary dataset in step 654 to generate an enhanced matched identity dataset, likewise described in greater detail herein. Otherwise, or once the enhanced matched identity dataset is generated in step 654, identity data enhancement operations are ended in step 656.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a data management operation, comprising:
receiving an original identity dataset, the original identity dataset comprising a plurality of records;
enhancing the plurality of records of the original identify dataset based upon a context to provide an enhanced identity dataset comprising a plurality of enhanced identity records; and,
performing a match operation on the enhanced identity dataset to provide an enhanced matched identity dataset comprising a plurality of enhanced matched identity records.

2. The method of claim 1, further comprising:
classifying the plurality of records of the original identity dataset to provide a classified identity dataset comprising a plurality of classified identity records; and wherein
the enhancing the plurality of records comprises enhancing the plurality of classified identity records to provide an enhanced identity dataset comprising a plurality of enhanced identity records.

3. The method of claim 1, further comprising:
performing a cross-reference operation on the enhanced match identity dataset to provide an enhanced matched identity dataset comprising a plurality of enhanced matched identity records.

4. The method of claim 1, wherein:
the match operation comprises performing a probabilistic match operation on the plurality of enhanced identity records to provide the enhanced matched identity dataset.

5. The method of claim 1, further comprising:
performing an analysis on the matched identity dataset, the analysis providing a degree of certainty regarding each of the plurality of enhanced match identity records.

6. The method of claim 1, wherein:
the enhancing includes an ability to control a threshold for a degree of certainty of a match.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving an original identity dataset, the original identity dataset comprising a plurality of records;
enhancing the plurality of records of the original identify dataset based upon a context to provide an enhanced identity dataset comprising a plurality of enhanced identity records; and,
performing a match operation on the enhanced identity dataset to provide an enhanced matched identity dataset comprising a plurality of enhanced matched identity records.

8. The system of claim 7, wherein the instructions executable by the processor are further configured for:
classifying the plurality of records of the original identity dataset to provide a classified identity dataset comprising a plurality of classified identity records; and wherein
the enhancing the plurality of records comprises enhancing the plurality of classified identity records to provide an enhanced identity dataset comprising a plurality of enhanced identity records.

9. The system of claim 7, wherein the instructions executable by the processor are further configured for:
performing a cross-reference operation on the enhanced match identity dataset to provide an enhanced matched identity dataset comprising a plurality of enhanced matched identity records.

10. The system of claim 7, wherein:
the match operation comprises performing a probabilistic match operation on the plurality of enhanced identity records to provide the enhanced matched identity dataset.

11. The system of claim 7, wherein the instructions executable by the processor are further configured for:
performing an analysis on the matched identity dataset, the analysis providing a degree of certainty regarding each of the plurality of enhanced match identity records.

12. The system of claim 7, wherein:
the enhancing includes an ability to control a threshold for a degree of certainty of a match.

13. A non-transitory, computer-readable storage medium embodying computer program code, the computer program code comprising computer executable instructions configured for:
receiving an original identity dataset, the original identity dataset comprising a plurality of records;
enhancing the plurality of records of the original identify dataset based upon a context to provide an enhanced identity dataset comprising a plurality of enhanced identity records; and,
performing a match operation on the enhanced identity dataset to provide an enhanced matched identity dataset comprising a plurality of enhanced matched identity records.

14. The non-transitory, computer-readable storage medium of claim 13, wherein the computer executable instructions are further configured for:
classifying the plurality of records of the original identity dataset to provide a classified identity dataset comprising a plurality of classified identity records; and wherein
the enhancing the plurality of records comprises enhancing the plurality of classified identity records to provide an enhanced identity dataset comprising a plurality of enhanced identity records.

15. The non-transitory, computer-readable storage medium of claim 13, wherein the computer executable instructions are further configured for:
performing a cross-reference operation on the enhanced match identity dataset to provide an enhanced matched identity dataset comprising a plurality of enhanced matched identity records.

16. The non-transitory, computer-readable storage medium of claim 13, wherein:
the match operation comprises performing a probabilistic match operation on the plurality of enhanced identity records to provide the enhanced matched identity dataset.

17. The non-transitory, computer-readable storage medium of claim 13, wherein the computer executable instructions are further configured for:
performing an analysis on the matched identity dataset, the analysis providing a degree of certainty regarding each of the plurality of enhanced match identity records.

18. The non-transitory, computer-readable storage medium of claim 13, wherein:
the enhancing includes an ability to control a threshold for a degree of certainty of a match.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
